(19) United States
(12) Patent Application Publication
(10) Pub. No.: US 2015/0178391 A1
(43) Pub. Date: Jun. 25, 2015

(54) INTENT BASED CONTENT RELATED SUGGESTIONS AS SMALL MULTIPLES

(71) Applicant: Microsoft Technology Licensing, LLC, Redmond, WA (US)

(72) Inventor: Shawn Villaron, Mountain View, CA (US)

(21) Appl. No.: 14/578,466

(22) Filed: Dec. 21, 2014

Related U.S. Application Data
(60) Provisional application No. 61/919,713, filed on Dec. 21, 2013.

(51) Int. Cl. G06F 17/30; G06F 3/0484; G06F 3/0482

(52) U.S. Cl. CPC G06F 17/30864; G06F 3/0482; G06F 3/04842

(57) ABSTRACT

Technologies are generally provided for creating content by detecting user intent and providing content related suggestions as small multiples. User intent may be determined from a number of different factors associated with user, document, and environment. Suggestions may then be presented through small multiples: galleries that combine multiple properties of content using the actual content user wants to create.

### CROSS REFERENCE TO RELATED APPLICATIONS

This Application claims benefit under 35 U.S.C §119 (e) of U.S. Provisional Application Ser. No. 61/919,713 filed on Dec. 21, 2013. The Provisional Application is herein incorporated by reference in its entirety.

### BACKGROUND

Content processing applications and services, especially textual content, provide a number of controls for selecting and modifying aspects of content, such as formatting, grammatical or stylistic corrections, even word replacements through synonym/antonym suggestions. In typical systems, such controls are available individually, sometimes independently or interdependently. Thus, users may be enabled to select and modify aspects of content they create or process, but they have to do it manually.

Furthermore, creating content to match a particular style (not necessarily formatting, but prose style) is mostly a manual process left to the user in conventional applications. For example, if an organization has a particular preference for not only formatting, but also choice of words, sentence structure, and similar aspects of documents created by its members, it may be a process left to individual users to learn and apply the organization's preferences.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to provision of intent based content related suggestions as small multiples, which may include determining an author intent based on an author attribute, a content context, a content attribute, a collaboration attribute, a trend, and/or a computing device attribute, identifying one or more content elements to be included in the content, and displaying two or more suggested combinations of the content elements to be included in the content as small multiples, where each small multiple may present a combination of two or more content using the identified content elements.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating a local and networked configuration environment, where intent based content related suggestions may be provided as small multiples;

FIG. 2 illustrates an example for content selection and ordering according to some embodiments;

FIG. 3A illustrates an example for presenting content related suggestions as small multiples according to some embodiments;

FIG. 3B illustrates implementation of a content related suggestion on a document canvas following selection of a small multiple;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of providing intent based content related suggestions as small multiples according to embodiments.

### DETAILED DESCRIPTION

As briefly described above, users may create content by selecting among content related suggestions presented as small multiples based on inferred user intent. User intent may be determined from a number of different factors associated with user, document, and environment. Suggestions may then be presented through the small multiples: galleries that combine multiple properties of content using the actual content user wants to create.

Provision of suggestions based on user, document type, similar documents, other people's choices, and similar considerations, may enable a user to create content quickly through selection and/or acceptance of the suggestions instead of manually setting various aspects of the content such as format, style, placement, and so on. Thus, saving the user valuable time that may be spent on the content creation, improving user efficiency. In some embodiments, the suggestions may be displayed to the user in an order according to their importance to the author (determined based on author intent), enhancing user interaction performance. Additionally, the user may be enabled to combine different suggestions and/or filter different content properties. Furthermore, in a collaborative environment, the provision of intent based content related suggestions as small multiples may allow created content from multiple co-authors to match a particular, uniform style, further increasing user interaction performance. For example, the same small multiples may be provided to the co-authors based on collaboration information such as identities/attributes of the collaborators, a type of the collaboration project, and similar factors considered in determining intent.

In further embodiments, suggested combinations of content elements to be included in the content may be displayed using reduced size versions of the identified content elements, which may enable less space to be required for display functionalities. By presenting the different combinations using the reduced size versions of the identified content elements, embodiments may also enable a user to visualize the created content more realistically and have an enhanced content creation experience, further improving usability.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for content creation based on selection of suggestions presented as small multiples determined from author intent. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

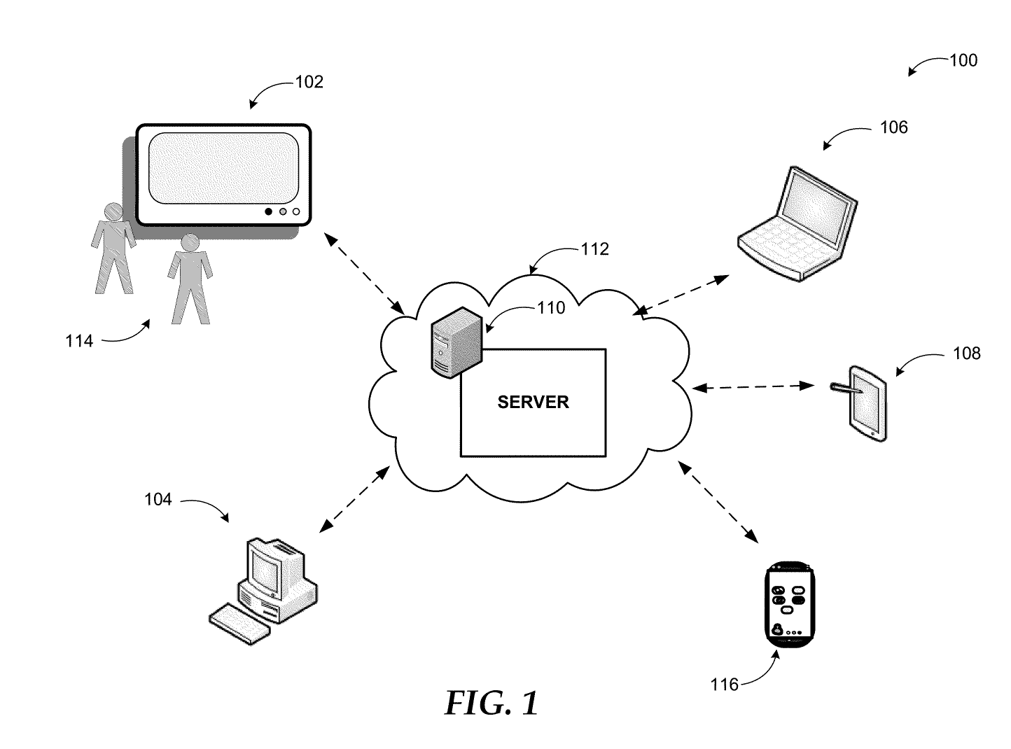

Referring to FIG. 1, conceptual diagram 100 illustrates a local and networked configuration environment, where intent based content related suggestions may be provided as small multiples. The computing devices and computing environments shown in diagram 100 are for illustration purposes. Embodiments may be implemented in various local, networked, and similar computing environments employing a variety of computing devices and systems.

Diagram 100 represents local computing environment in a computing device, where an authoring application may enable one or more users such as users 114 to create and process content individually or collaboratively. The authoring application may be executed as a locally installed application on a desktop computer 104, a laptop computer 106, a tablet 108, a smart phone 116, a smart whiteboard 102, and similar devices. The authoring application may also be part of a hosted service executed on a server 110 and accessed by client devices through a network 112.

The authoring application may determine author intent based on a number of factors associated with the author, a document (including the content) being created, an environment associated with the author/content (e.g., a collaboration environment), and external factors such as crowd sourcing. Based on the determined intent, the authoring application may provide automated content related suggestions such as placement, formatting, style selection, relationships between content elements, size and attribute selection for content elements, layout of content elements, animations, transitions, and/or accessibility options. The suggestions may be presented in form of small multiples that combine multiple properties of content using actual content. For example, a placement, size, font type, and color of textual content created by the author may be presented in various combinations in the small multiples using the created textual content itself as opposed to sample text. Upon selection of one of the small multiples, the selected combination of properties may be applied to the created content on a document canvas.

The authoring application may be a word processing application, a presentation application, a spreadsheet application, a note taking application, a collaboration application with a content editing module, and comparable ones.

The example systems in FIG. 1 have been described with specific servers, client devices, applications, and interactions. Embodiments are not limited to systems according to these example configurations. A platform providing intent based content related suggestions as small multiples may be implemented in configurations employing fewer or additional components and performing other tasks. Furthermore, specific protocols and/or interfaces may be implemented in a similar manner using the principles described herein.

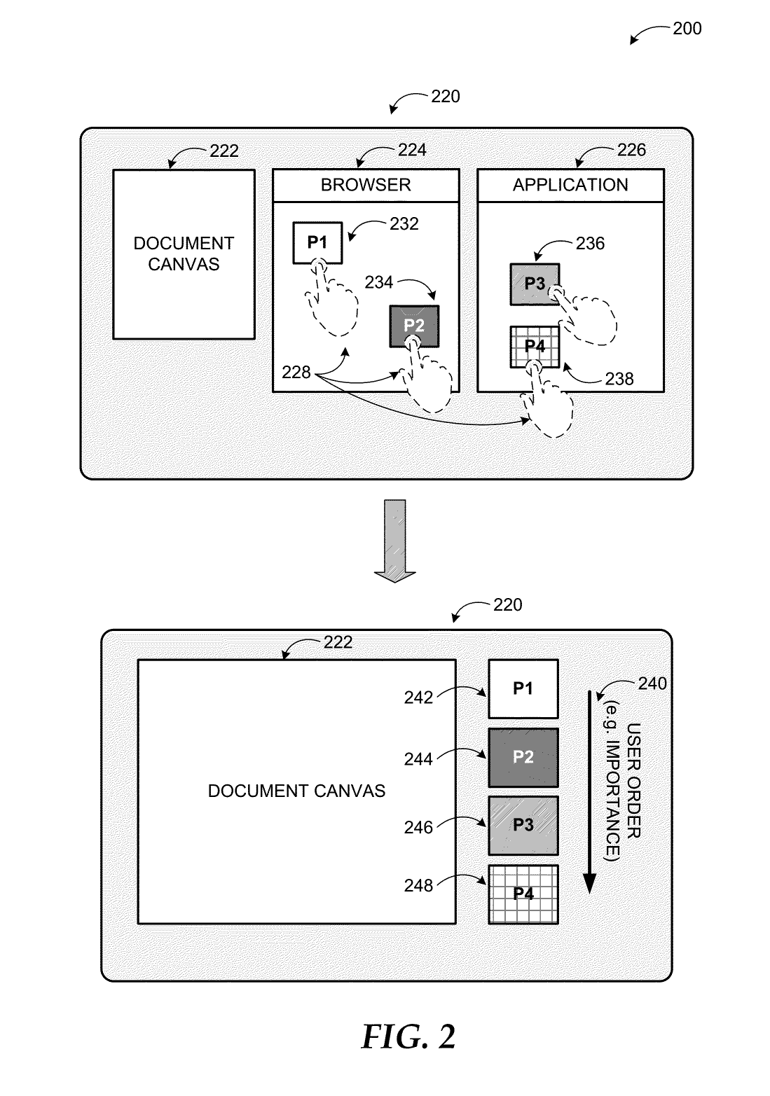

Referring to FIG. 2, diagram 200 illustrates an example for content selection and ordering according to some embodiments. Created or modified content according to embodiments may include text, images, graphics, and/or embedded objects such as audio or video objects.

In some examples, author intent may be determined from one or more author attributes such as an organizational position, a professional status, an identity, and/or a social status. The author attribute may be determined from the author's sign-on credentials, a computing device used to execute or access the authoring application, or comparable methods. A document context such as a storage location (e.g., a cloud) for the content, related documents, prior versions, etc. may also be used to determine author intent. Furthermore, collaboration information such as identities/attributes of the collaborators, a type of the collaboration project, and similar factors may also be considered.

Moreover, a document attribute such as a type of the document containing the content, one or more restrictions imposed on the document, modifications to the document, and so on may also be used to determine author intent. In other examples, the author intent may be further determined from trends in the Internet, trends among peers, and/or organizational norms. Yet another factor that may be considered in determining author intent may be a type of computing device used by the author such as a mobile device, a laptop device, a desktop computer, and comparable ones.

Once author intent is determined, one or more content actions may be identified based on the author intent. The content actions may include decisions on placement of content, formatting of content, style of content, relationships between content elements, sizing of content/content elements, layout of content elements, animations associated with content elements, motion paths for animated content elements, and or accessibility options (e.g., visual impairedness, readable text, etc.). These actions may be determined and automatically decided based on determined author intent.

In some embodiments, content actions may include replacement of portions of the content. For example, images may be replaced with textual portions and vice versa or same type of portions (text, image, graphics, etc.) may be switched to emphasize the determined author intent. In addition, attributes of content elements such as font type, font size, boldness, etc. of textual content; frame type, size, shading of an image, thickness of lines, colors, and so on may be selected to emphasize the author intent and/or what is determined to be a theme of the created content. For example, upon determining the theme of the content, one or more sentences within the content summarizing or representing that theme may be bolded or italicized. Similarly, a title or header may be created and suitably placed based on the determined theme of the content.

Diagram 200 shows one example for content creation based on author intent. According to the example scenario, content elements P1 through P4 (232, 234, 236, 238), which may be selected by the author directly from available content elements or from user interfaces of one or more applications (e.g., browser user interface 224 and application user interface 226) or through inference (e.g., author's hovering over an image may be interpreted as author intent and hovered-on image may be suggested for inclusion in the created content). In the illustrated scenario, the author may select the content elements through touch actions 228 for inclusion in the content being created on document canvas 222 shown on the display 220.

A system according to embodiments may subsequently display the selected content elements as small multiples 242, 244, 246, and 248 in order 240 according to their importance to the author (determined based on author intent as discussed above) adjacent to document canvas 222 on the display 220.

The small multiples 242, 244, 246, and 248 may present combinations of multiple properties of the selected content elements. For example, small multiple 242 may display the selected content element 232 with particular color, shading, frame type, size, etc. properties while other selected content elements may be displayed with other property combinations in small multiples 244, 246, and 248.

The property combinations displayed in small multiples 242, 244, 246, and 248 may represent a top choice according to an algorithm determining author intent (as well as the type of content being created, an environment of the content, etc.). Upon detecting author interest on a small multiple (e.g., small multiple 242), the system may display other options, for example, adjacent to the top choice, in a pop-up menu, or through other means presenting possible re-combinations of the combined properties of the content element associated with the small multiple. If the author selects the small multiple (e.g., clicks on it), the content element represented by the selected small multiple may be inserted into the created content with the displayed combination of properties.

An authoring application according to embodiments may be part of a hosted service and accessed by a user through a thin or thick client application such as a browser. The authoring application may also be a locally installed and executed application.

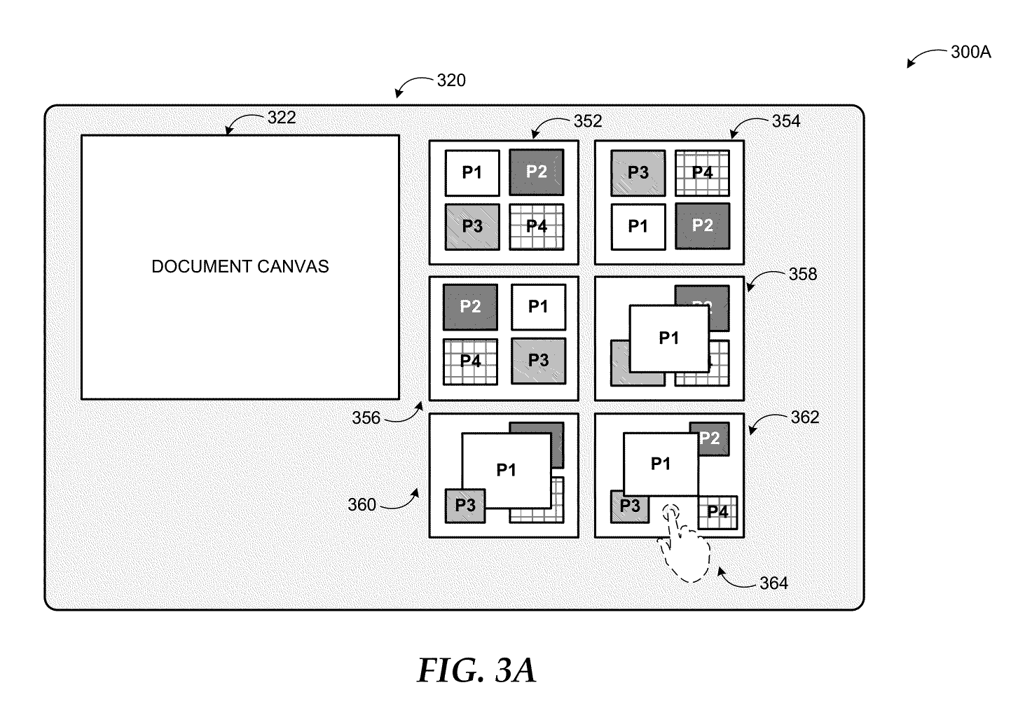

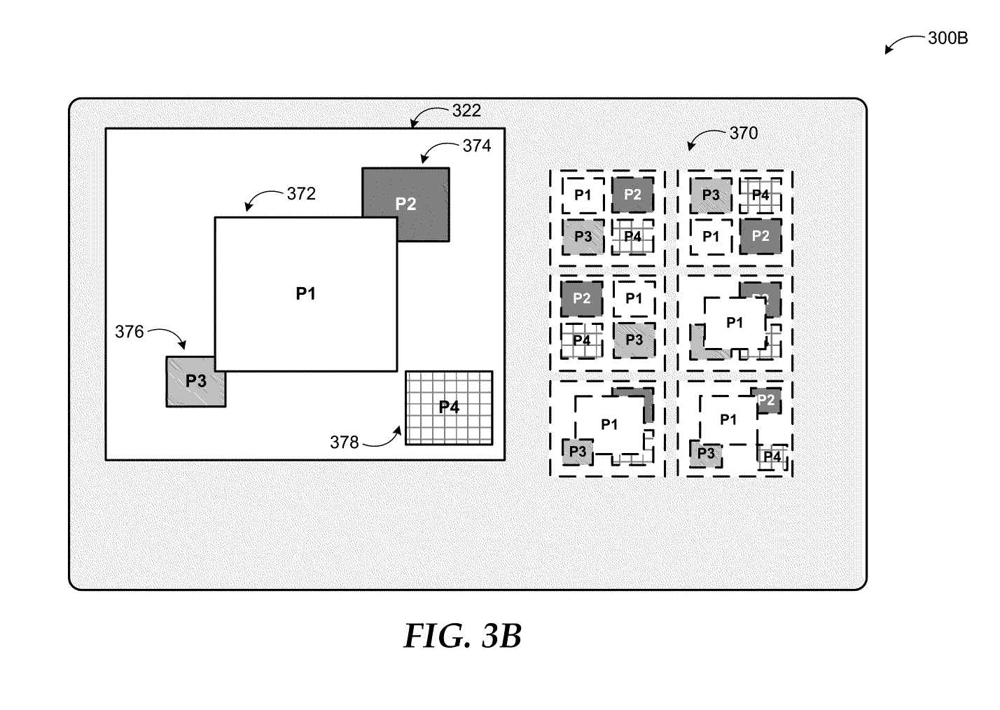

FIG. 3A illustrates an example for presenting content related suggestions as small multiples according to some embodiments in diagram 300A.

Upon identifying content elements to be included in the created content through direct author selection or other means, a system according to embodiments may determine various attributes/properties of the content elements and generate various combinations of content element placements based on author intent. For example, the selected content elements may be images or graphics to be included in the content on document canvas 322 on user interface 320. The system may determine an importance of each content element for the author in context of the content being created and generate suggested placement combinations presented as small multiples 352, 354, 356, 358, 360, and 362.

In addition to displaying different placements of the selected content elements, the small multiples 352, 354, 356, 358, 360, and 362 may also vary sizes and/or other properties of the selected content elements. By presenting the different combinations as small multiples of the actual content elements, embodiments enable a user to visualize the created content more realistically and have an enhanced content creation experience. The author may be enabled to select one of the combinations (small multiple 362) through a touch action 364, for example, and have the suggested placement and other property combination placed on the document canvas 322.

FIG. 3B illustrates implementation of a content related suggestion on a document canvas following selection of a small multiple.

Following on the example scenario of FIG. 3A, diagram 300B shows a combination of content elements 372, 374, 376, and 378 placed on the document canvas 322 as suggested by a selected small multiple (small multiple 362). In some examples, further combinations of content elements may be presented as small multiples 370. The small multiples 370 may be variations of the combination of properties in the selected small multiple (small multiple 362) that is already placed on the document canvas 322. For example, small multiples 370 may vary sizes, shading, color, or similar properties of individual content elements on the document canvas 322 without resetting their individual locations or relationships to each other. Again, the suggestions in the small multiples may use the actual content elements enabling a realistic visualization of options for the created content.

Authors may also be enabled to combine different suggestions and/or filter different properties (e.g., indicate through a filtering user interface to see small multiples varying two or more selected properties). Furthermore, a learning algorithm may be employed to dynamically adjust intent determination and content action identification, thereby enhancing a success of suggestions/prioritization of small multiples based on the user's own usage, other people related to the user (e.g., in the same organization, a professional network, a social network, others that create/consume similar content, etc.) over time Property changes between different suggestions may apply to text, images, graphics, audio/video objects, etc.

The examples in FIG. 1 through 3B have been described with specific user interface elements, configurations, and presentations. Embodiments are not limited to systems according to these example configurations. Intent based authoring may be implemented in configurations using other types of user interface elements, presentations, and configurations in a similar manner using the principles described herein.

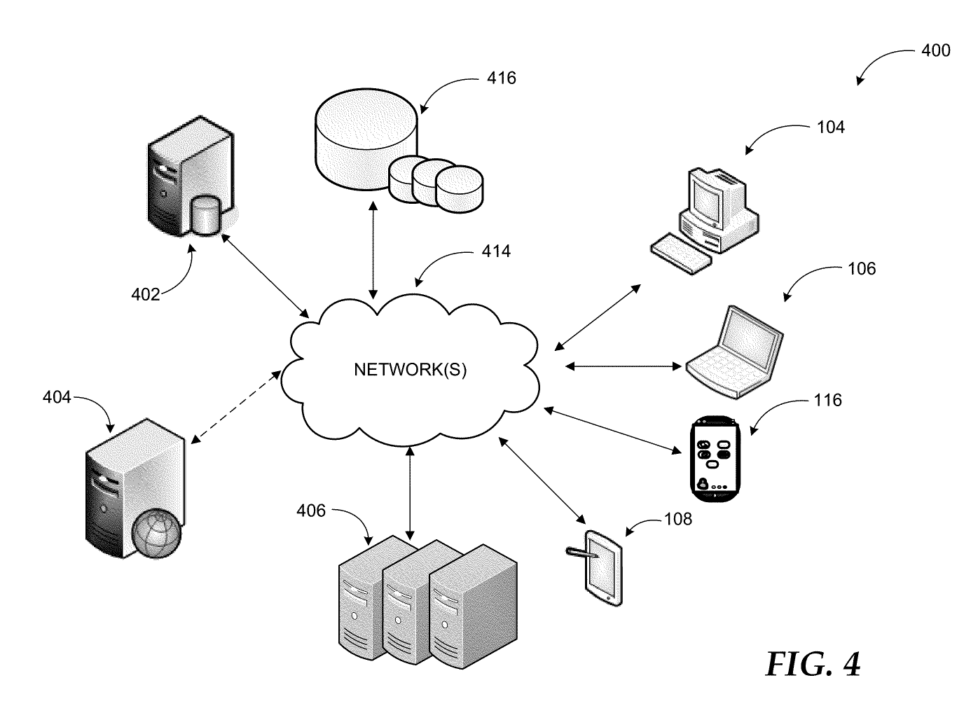

FIG. 4 is an example networked environment, where embodiments may be implemented. A system providing intent based content related suggestions as small multiples may be implemented via software executed over one or more servers 406 such as a hosted service. The platform may communicate with client applications on individual computing devices such as the desktop computer 104, laptop computer 106, smart phone 116, and tablet 108 (‘client devices’) through network(s) 414.

Client applications executed on any of the client devices may facilitate communications with hosted authoring applications executed on servers 406, or on individual server 404. An authoring application executed on one of the servers may facilitate determination of author intent, presentation of content related suggestions as small multiples as discussed above. The authoring application may retrieve relevant data from data store(s) 416 directly or through database server 402, and provide requested services to the user(s) through the client devices.

Network(s) 414 may comprise any topology of servers, clients, Internet service providers, and communication media. A system according to embodiments may have a static or dynamic topology. Network(s) 414 may include secure networks such as an enterprise network, an unsecure network such as a wireless open network, or the Internet. Network(s) 414 may also coordinate communication over other networks such as Public Switched Telephone Network (PSTN) or cellular networks. Furthermore, network(s) 414 may include short range wireless networks such as Bluetooth or similar ones. Network(s) 414 provide communication between the nodes described herein. By way of example, and not limitation, network(s) 414 may include wireless media such as acoustic, RF, infrared and other wireless media.

Many other configurations of computing devices, applications, data sources, and data distribution systems may be employed to implement a platform responsive to individual user intent and directed to providing content action suggestions based on user intent. Furthermore, the networked environments discussed in FIG. 4 are for illustration purposes only. Embodiments are not limited to the example applications, modules, or processes.

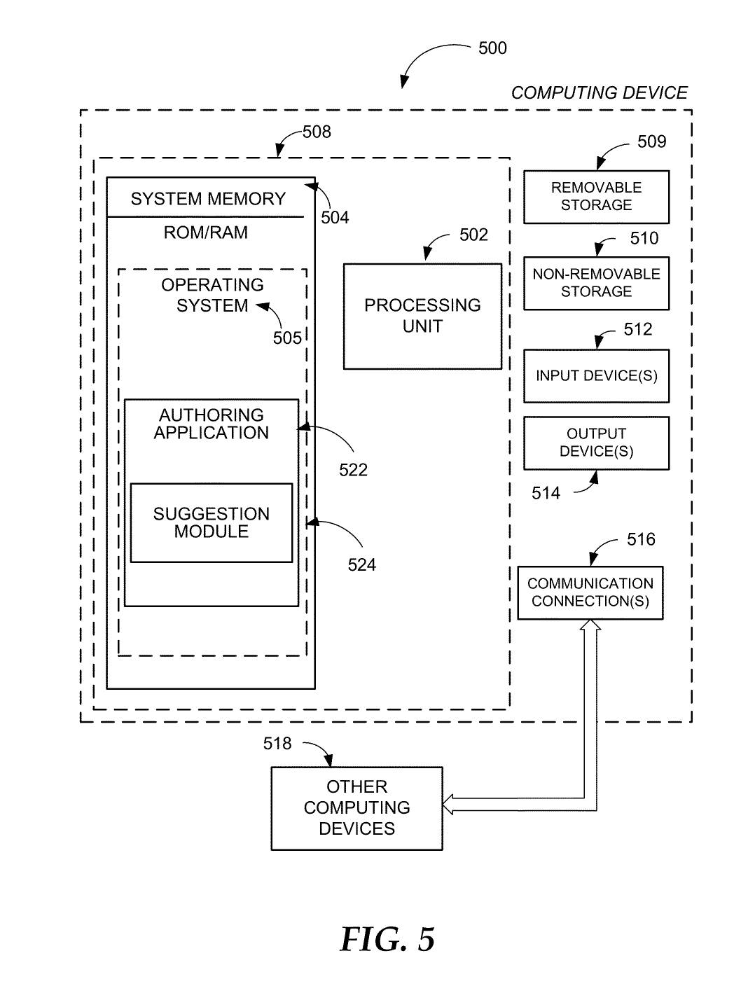

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as the computing device. In a basic configuration, computing device may be any computing device with communication capabilities, and include at least one processing unit 502 and a system memory 504. The computing device 500 may also include a plurality of processing units that cooperate in executing programs. Depending on the exact configuration and type of computing device, a system memory 504 may be volatile (such as RAM), non-volatile (such as ROM, flash memory, etc.) or some combination of the two. The system memory 504 typically includes an operating system 505 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as authoring application 522 and suggestion module 524.

The authoring application 522 may determine an author's intent based on a number of factors associated with the author, the content being created, and an environment. The authoring application 522 may then provide suggestions for various content element combinations (based on their properties) through the suggestion module 524 as described herein. The authoring application 522 and the suggestion module 524 may be separate applications or integrated modules of a hosted service. This basic configuration is illustrated in FIG. 5 by those components within a dashed line 508.

The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer readable storage media may include volatile and nonvolatile, removable and non-removable media implemented in any method or technology for storage of information, such as computer readable instructions, data structures, program modules, or other data. The system memory 504, removable storage 509 and the non-removable storage 510 are all examples of computer readable memory device. Computer readable memory devices include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by the computing device 500. Any such computer readable storage media may be part of the computing device 500. The computing device 500 may also have the input device(s) 512 such as keyboard, mouse, pen, voice input device, touch input device, an optical capture device for detecting gestures, and comparable input devices. An output device(s) 514 such as a display, speakers, printer, and other types of output devices may also be included. These devices are well known in the art and need not be discussed at length here.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones. Examples of memory devices as various implementations of hardware are discussed above.

The computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers and other comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

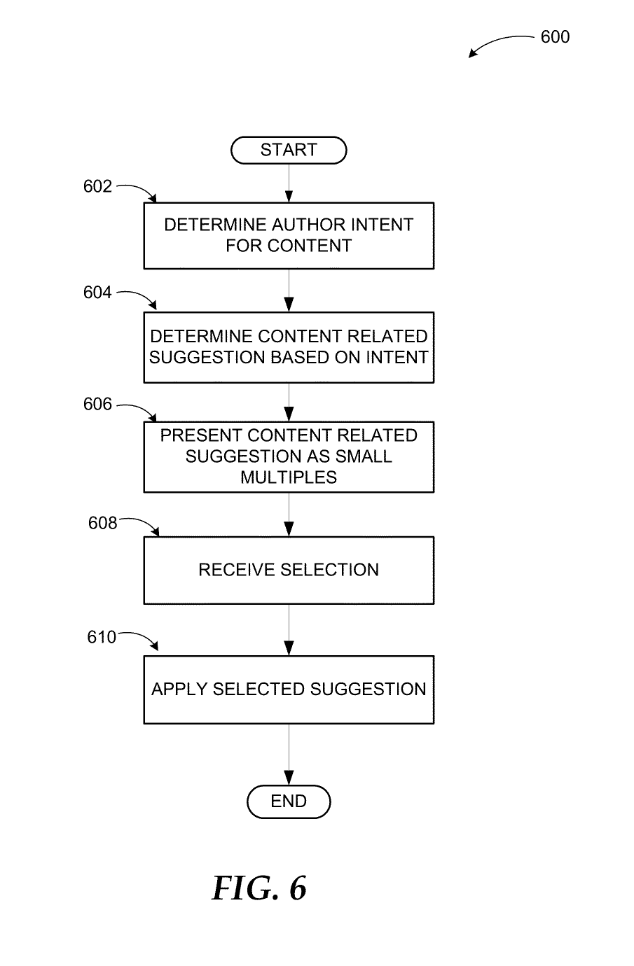

FIG. 6 illustrates a logic flow diagram for a process 600 of providing intent based content related suggestions as small multiples according to embodiments. The process 600 may be implemented on a server or other computing device.

The process 600 begins with an operation 602, where author intent may be determined based on author's attributes, a document context, collaboration information, document attributes, trends (e.g., crowd sourcing), and/or a computing device attribute. At operation 604, content related suggestions such as placement, formatting, style, or layout of content various content elements may be determined based on the author intent. Furthermore, relationships, sizes, animations associated with, motion paths, and attributes of the content elements may also be determined based on the author intent.

At operation 606, the determined content related suggestions may be presented to the author through small multiples, which may combine multiple properties (of the above described list or more) of actual content elements to be included in the created content.

At operation 608, a selection of one of the small multiples may be received and the combination of content element properties represented by the selected small multiple may be applied to the content elements on a document canvas at operation 610.

The operations included in the process 600 are for illustration purposes. Intent based content related suggestions as small multiples may be implemented by similar processes with fewer or additional steps, as well as in different order of operations using the principles described herein.

A means for providing intent based content related suggestions as small multiples may include a means for determining an author intent based on an author attribute, a content context, a content attribute, a collaboration attribute, a trend, and/or a computing device attribute, a means for identifying one or more content elements to be included in the content, and a means for displaying two or more suggested combinations of the content elements to be included in the content as small multiples, where each small multiple may present a combination of two or more content using the identified content elements.

According to some examples, methods for providing intent based content related suggestions as small multiples are provided. An example method, executed at least in part in a computing device, may include determining an author intent based on an author attribute, a content context, a content attribute, a collaboration attribute, a trend, and/or a computing device attribute, identifying one or more content elements to be included in the content, and displaying two or more suggested combinations of the content elements to be included in the content as small multiples, where each small multiple may present a combination of two or more content element properties using the identified content elements.

In other examples, two or more suggested combinations of the content elements to be included in the content may be displayed using reduced size versions of the identified content elements. Two or more content element properties in each small multiple may be displayed combining two or more of a placement of the content elements, a formatting of the content elements, a style of the content elements, one or more relationships between content elements, a size of the content elements, an attribute of the content elements, a layout of the content elements, an animation associated with the content elements, a motion path for the content elements, and one or more accessibility options. The small multiples may be displayed as representing a top choice of property combinations for the content elements based on the determined author intent in context of the content. Upon detecting an author interest in one of the displayed small multiples, one or more additional small multiples representing variations of the combination of properties represented by the small multiple of interest may be displayed.

In further examples, the author interest in one of the displayed small multiples may be detected based on a hover action with one of a mouse and a pen or a swipe action ending on the small multiple of interest. Upon selection of one of the small multiples, the combination of content element properties represented by the selected small multiple may be applied to the content on a document canvas. The selection the small multiple may be detected through a keyboard entry combination, a mouse click, a pen tap, a finger tap, a tapping gesture, an eye tracking motion, or a voice command. The content elements may include text, an image, a graphic, and an embedded object. The author intent may be determined by analyzing an organizational position of the author, a professional status of the author, an identity of the author, a social status of the author, a storage location of the content, one or more documents related to the content, one or more prior versions of the content, a type of the content, a restriction imposed on the content, one or more modifications on the content, analyzing one or more of collaborators, a collaboration project, a type of computing device associated with the author, a trend among peers of the author, an organizational norm, and/or a trend in the Internet.

According to some embodiments, computing devices for providing intent based content related suggestions as small multiples are described. An example, computing device may include a memory, a display, and a processor coupled to the memory and the display, the processor executing an authoring application. The authoring application may be configured to determine an author intent based on an author attribute, a content context, a content attribute, a collaboration attribute, a trend, and/or a computing device attribute, identify one or more content elements to be included in the content, display two or more suggested combinations of the content elements to be included in the content as small multiples, where each small multiple may present a combination of two or more content element properties using the identified content elements, detect a selection of one of the small multiples, and apply the combination of content element properties represented by the selected small multiple to the content on a document canvas.

In other embodiments, the small multiples may represent variations of a combination of properties for content elements already placed on the document canvas. The authoring application may be further configured enable an author to combine multiple suggestions. The authoring application may be further configured to enable an author to filter properties represented in the small multiples. The authoring application may be further configured to present a filter selection user interface for identifying one or more properties to be one of included and excluded in the displayed small multiples. The authoring application may be a locally installed application or a hosted service, and the computing device may be a server, a desktop computer, a laptop computer, a tablet, a smart whiteboard, or a smart phone.

According to some examples, computer-readable memory devices with instructions stored thereon for providing intent based content related suggestions as small multiples are described. Example instructions may include determining an author intent based on an author attribute, a content context, a content attribute, a collaboration attribute, a trend, and/or a computing device attribute, identifying one or more content elements to be included in the content, displaying, two or more suggested combinations of the content elements to be included in the content as small multiples, where each small multiple may present a combination of two or more content element properties using the identified content elements, detecting a selection of one of the small multiples, and applying the combination of content element properties represented by the selected small multiple to the content on a document canvas.

In other examples, the small multiples may be displayed adjacent to the document canvas according to an order of significance to the author based on the determined author intent. A learning algorithm may be employed to adjust intent determination and content element combination for the small multiples. The learning algorithm may be employed to prioritize the small multiples based on the author's own usage and other people related to the author.

The above specification, examples and data provide a complete description of the manufacture and use of the composition of the embodiments. Although the subject matter has been described in language specific to structural features, and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing intent based content related suggestions as small multiples, the method comprising:
determining an author intent based on one or more of an author attribute, a content context, a content attribute, a collaboration attribute, a trend, and a computing device attribute;
identifying one or more content elements to be included in the content; and
displaying two or more suggested combinations of the content elements to be included in the content as small multiples, wherein each small multiple presents a combination of two or more content element properties using the identified content elements.

2. The method of claim 1, further comprising displaying two or more suggested combinations of the content elements to be included in the content using reduced size versions of the identified content elements.

3. The method of claim 1, further comprising displaying two or more content element properties in each small multiple combining two or more of a placement of the content elements, a formatting of the content elements, a style of the content elements, one or more relationships between content elements, a size of one or more content elements, an attribute of one or more content elements, a layout of the content elements, an animation associated with the one or more content elements, a motion path for the one or more content elements, and one or more accessibility options.

4. The method of claim 1, further comprising displaying the small multiples as representing a top choice of property combinations for the one or more content elements based on the determined author intent in context of the content.

5. The method of claim 4, further comprising upon detecting an author interest in one of the displayed small multiples, presenting one or more additional small multiples representing variations of the combination of properties represented by the small multiple of interest.

6. The method of claim 5, wherein the author interest in one of the displayed small multiples is detected based on one of: a hover action with one of a mouse and a pen and a swipe action ending on the small multiple of interest.

7. The method of claim 1, further comprising upon selection of one of the small multiples applying the combination of content element properties represented by the selected small multiple to the content on a document canvas.

8. The method of claim 7, further comprising detecting the selection of one of the small multiples through one of a keyboard entry combination, a mouse click, a pen tap, a finger tap, a tapping gesture, an eye tracking motion, and a voice command.

9. The method of claim 1, wherein the content elements include text, an image, a graphic, and an embedded object.

10. The method of claim 1, wherein determining the author intent comprises analyzing one or more of an organizational position of the author, a professional status of the author, an identity of the author, a social status of the author, a storage location of the content, one or more documents related to the content, one or more prior versions of the content, a type of the content, a restriction imposed on the content, one or more modifications on the content, analyzing one or more of collaborators, a collaboration project, a type of computing device associated with the author, a trend among peers of the author, an organizational norm, and a trend in the Internet.

11. A computing device for providing intent based content related suggestions as small multiples, the computing device comprising:
a memory;
a display; and
a processor coupled to the memory and the display, the processor executing an authoring application, wherein the authoring application is configured to:
determine an author intent based on one or more of an author attribute, a content context, a content attribute, a collaboration attribute, a trend, and a computing device attribute;
identify one or more content elements to be included in the content;
display two or more suggested combinations of the content elements to be included in the content as small multiples, wherein each small multiple presents a combination of two or more content element properties using the identified content elements;
detect a selection of one of the small multiples; and
apply the combination of content element properties represented by the selected small multiple to the content on a document canvas.

12. The computing device of claim 11, wherein the small multiples represent variations of a combination of properties for content elements already placed on the document canvas.

13. The computing device of claim 11, wherein the authoring application is further configured enable an author to combine multiple suggestions.

14. The computing device of claim 11, wherein the authoring application is further configured to enable an author to filter properties represented in the small multiples.

15. The computing device of claim 14, wherein the authoring application further configured to present a filter selection user interface for identifying one or more properties to be one of included and excluded in the displayed small multiples.

16. The computing device of claim 11, wherein the authoring application is one a locally installed application and a hosted service, and the computing device is one of: a server, a desktop computer, a laptop computer, a tablet, a smart whiteboard, and a smart phone.

17. A computer-readable memory device with instructions stored thereon for providing intent based content related suggestions as small multiples, the instructions comprising:
determining an author intent based on one or more of an author attribute, a content context, a content attribute, a collaboration attribute, a trend, and a computing device attribute;
identifying one or more content elements to be included in the content;
displaying two or more suggested combinations of the content elements to be included in the content as small multiples, wherein each small multiple presents a combination of two or more content element properties using the identified content elements;
detecting a selection of one of the small multiples; and
applying the combination of content element properties represented by the selected small multiple to the content on a document canvas.

18. The computer-readable memory device of claim 17, wherein the instructions further comprise displaying the small multiples adjacent to the document canvas according to an order of significance to the author based on the determined author intent.

19. The computer-readable memory device of claim 17, wherein the instructions further comprise employing a learning algorithm to adjust intent determination and content element combination for the small multiples.

20. The computer-readable memory device of claim 19, wherein the instructions further comprise employing the learning algorithm to prioritize the small multiples based on the author's own usage and other people related to the author.
